(19) United States
(12) Patent Application Publication
(10) Pub. No.: US 2025/0300234 A1
(43) Pub. Date: Sep. 25, 2025

(54) BIPOLAR BATTERY

(71) Applicant: TOYOTA JIDOSHA KABUSHIKI KAISHA, Toyota-shi (JP)

(72) Inventors: Yoshiro OBAYASHI, Toyota-shi (JP); Masahiro ISHIZUKA, Toyota-shi (JP); Takeru HARA, Toyota-shi (JP); Tetsuya MIMURA, Chiryu-shi (JP); Tatsuya KINUGAWA, Kariya-shi (JP); Yusuke YAMAGUCHI, Kariya-shi (JP)

(73) Assignee: TOYOTA JIDOSHA KABUSHIKI KAISHA, Toyota-shi (JP)

(21) Appl. No.: 19/046,695

(22) Filed: Feb. 6, 2025

(30) Foreign Application Priority Data
Mar. 25, 2024 (JP) 2024-048731

(51) Int. Cl. H01M 10/0585; H01M 10/0525; H01M 50/193; H01M 50/198

(52) U.S. Cl. CPC H01M 10/0585; H01M 10/0525; H01M 50/193; H01M 50/198

(57) ABSTRACT

A bipolar battery includes a positive electrode current collector, a positive electrode mixture layer, a separator, a negative electrode mixture layer, and a negative electrode current collector, which are layered one on another. The bipolar battery further includes a resin sealing layer that includes a low rigidity material layer which has a tensile modulus of elasticity of less than 35.0 kgf/mm² and which is joined to the positive electrode current collector or the negative electrode current collector, and a high rigidity material layer which has a tensile modulus of elasticity of 35.0 kgf/mm² or more and which is disposed on a face of the low rigidity material layer that is opposite from a face thereof that is joined to the positive electrode current collector or the negative electrode current collector.

### CROSS-REFERENCE TO RELATED APPLICATION

This application is based on and claims priority under 35 USC 119 from Japanese Patent Application No. 2024-048731, filed on Mar. 25, 2024, the disclosure of which is incorporated by reference herein.

### BACKGROUND

### Technical Field

The present disclosure relates to a bipolar battery.

### Background Art

Conventionally, a bipolar battery has been used in which plural bipolar electrodes, each including a negative electrode active material layer at one face of a current collector and a positive electrode active material layer at another face of the current collector, are stacked with a separator interposed therebetween.

For example, Japanese Patent Application Laid-Open (JP-A) No. 2022-069042 discloses an electric storage cell including a reinforcing member that reinforces an uncoated portion of a current collector at which a positive electrode active material layer and a negative electrode active material layer are not provided, the current collector including the uncoated portion between a spacer and an active material layer when viewed from a direction in which active material layers in a positive electrode and a negative electrode face each other, and the reinforcing member being disposed along the uncoated portion so as to spread over the boundary between the positive electrode active material layer and the uncoated portion, the boundary between the negative electrode active material layer and the uncoated portion, and the boundary between the spacer and the uncoated portion, when viewed from the direction in which the active material layers face each other.

For example, Japanese Patent Application Laid-Open (JP-A) No. 2021-197204 discloses a battery including: a stack body including a current collector layer, an active material layer, and an electrolyte layer; a resin layer that covers at least a side face of the stack body; and a housing that accommodates the stack body coated with the resin layer, wherein the resin layer includes at least a first resin layer and a second resin layer successively disposed from the side face of the stack body toward the housing, the second resin layer is in contact with the housing, and the Young's modulus of the second resin layer is smaller than the Young's modulus of the first resin layer.

For example, Japanese Patent Application Laid-Open (JP-A) No. 2023-068843 discloses an all-solid-state battery including a stack body including a negative electrode current collector, a negative electrode active material layer, a solid electrolyte layer, a positive electrode active material layer, and a positive electrode current collector in this order, wherein, in a case in which the negative electrode active material layer, the solid electrolyte layer, and the positive electrode active material layer together form a power generating element, the stack body includes a protective layer disposed at a side face of the power generating element, the protective layer contains a resin having tackiness, and the stack body includes a film at at least one of between the negative electrode current collector and the protective layer, or between the positive electrode current collector and the protective layer, in a cross-sectional view along a layer-stacking direction of the all-solid battery.

### SUMMARY

Explanation follows regarding a bipolar battery in which a negative electrode current collector, a negative electrode mixture layer, a separator, a positive electrode mixture layer, and a positive electrode current collector are layered. Heat sealing (thermal fusion) is carried out when resin sealing layers are disposed respectively at a region of the positive electrode current collector at which the positive electrode mixture layer is not formed (positive electrode mixture unformed region) and at a region of the negative electrode current collector at which the negative electrode mixture layer is not formed (negative electrode mixture unformed region). At that time, wrinkles may occur, or warping may occur, at the positive electrode mixture unformed region of the positive electrode current collector and the negative electrode mixture unformed region of the negative electrode current collector.

The present disclosure has been made in consideration of the aforementioned circumstances, and the present disclosure addresses provision of a bipolar battery in which generation of wrinkles and warping at a positive electrode mixture unformed region of a positive electrode current collector and a negative electrode mixture unformed region of a negative electrode current collector is reduced.

### Means for Solving the Problem

Aspects of the present disclosure include the following.

<1> A bipolar battery, including:
a separator;
a positive electrode mixture layer layered on one side of the separator;
a positive electrode current collector layered on a face of the positive electrode mixture layer at a side opposite from the separator;
a negative electrode mixture layer layered on the other side of the separator; and
a negative electrode current collector layered on a face of the negative electrode mixture layer at a side opposite from the separator,
wherein the separator, the positive electrode mixture layer, the positive electrode current collector, the negative electrode mixture layer, and the negative electrode current collector are layered one on another,
wherein, when viewed from a layer-stacking direction, the bipolar battery includes a positive electrode mixture unformed region at which the positive electrode mixture layer is not formed on a face of the positive electrode current collector, and includes a negative electrode mixture unformed region at which the negative electrode mixture layer is not formed on a face of the negative electrode current collector, and
wherein the bipolar battery includes a resin sealing layer that includes a low rigidity material layer which has a tensile modulus of elasticity of less than 35.0 kgf/mm² and which is joined to the positive electrode current collector or the negative electrode current collector, and a high rigidity material layer which has a tensile modulus of elasticity of 35.0 kgf/mm² or more and which is disposed on a face of the low rigidity material layer that is opposite from a face thereof that is joined to the positive electrode current collector or the negative electrode current collector.
<2> The bipolar battery according to <1>, wherein the resin sealing layer is layered on a face of the positive electrode current collector at a side opposite from the positive electrode mixture layer in the positive electrode mixture unformed region, and on a face of the negative electrode current collector at a side opposite from the negative electrode mixture layer in the negative electrode mixture unformed region.
<3> The bipolar battery according to <1>or <2>, wherein the tensile modulus of elasticity of the low rigidity material layer is from 1.4 kgf/mm² to 26.7 kgf/mm², and the tensile modulus of elasticity of the high rigidity material layer is from 42.2 kgf/mm² to 127.0 kgf/mm².
<4> The bipolar battery according to any one of <1>to <3>, wherein the low rigidity material layer includes at least one selected from a low density polyethylene or an ethylene-vinyl acetate copolymer resin, and the high rigidity material layer includes at least one selected from an ionomer, a cast polypropylene, or a high density polyethylene.
<5> The bipolar battery according to any one of <1>to <4>, wherein the resin sealing layer consists of two layers, which are the low rigidity material layer and the high rigidity material layer.

### Effect of the Invention

The present disclosure provides a bipolar battery in which generation of wrinkles and warping at a positive electrode mixture unformed region of a positive electrode current collector and a negative electrode mixture unformed region of a negative electrode current collector is reduced.

### BRIEF DESCRIPTION OF THE DRAWINGS

FIG. 1 is a schematic cross-sectional view illustrating an example of a bipolar battery according to an embodiment of the present disclosure.

FIG. 2 is a schematic cross-sectional view illustrating an enlarged view of a portion of the bipolar battery illustrated in FIG. 1.

FIG. 3 is a schematic cross-sectional view illustrating an enlarged view of a portion of another example of a bipolar battery according to an embodiment of the present disclosure.

### DETAILED DESCRIPTION OF THE INVENTION

Embodiments, which are examples of the present disclosure, will be explained below. These explanations and examples illustrate embodiments and do not limit the scope of the invention.

In numerical ranges that are described in a stepwise manner in the present specification, the upper limit value or lower limit value that is described in one numerical range may be replaced with the upper limit value or lower limit value of another numerical range included in the stepwise numerical ranges. Further, in numerical ranges that are described in the present specification, the upper limit value or lower limit value of a numerical range may be replaced with a value that is shown in an example.

Respective components may contain plural kinds of corresponding substances.

When reference is made to the amount of a component contained in a composition, in cases in which plural substances corresponding to the component are present in the composition, this means a total amount of the plural substances present in the composition, unless specifically stated otherwise.

### Bipolar Battery

A bipolar battery according to an embodiment of the present disclosure includes:
a separator;
a positive electrode mixture layer layered on one side of the separator;
a current collector (positive electrode current collector) layered on a face of the positive electrode mixture layer at a side opposite from the separator;
a negative electrode mixture layer layered on the other side of the separator; and
a current collector (negative electrode current collector) layered on a face of the negative electrode mixture layer at a side opposite from the separator.

In the aforementioned bipolar battery, plural bipolar electrodes, including a negative electrode mixture layer disposed on one side of a current collector and including a positive electrode mixture layer disposed on the other face of the current collector, are stacked with a separator interposed therebetween.

When viewed from the layer-stacking direction, the aforementioned bipolar battery has a positive electrode mixture unformed region at which the positive electrode mixture layer is not formed on a face of the positive electrode current collector, and has a negative electrode mixture unformed region at which the negative electrode mixture layer is not formed on a face of the negative electrode current collector.

Further, the aforementioned bipolar battery includes a resin sealing layer including a low rigidity material layer which has a tensile modulus of elasticity of less than 35.0 kgf/mm² and which is joined to a positive electrode current collector or a negative electrode current collector, and a high rigidity material layer which has a tensile modulus of elasticity of 35.0 kgf/mm² or more and which is disposed on a face of the low rigidity material layer that is opposite from a face thereof that is joined to the positive electrode current collector or the negative electrode current collector. Namely, the resin sealing layer has a configuration in which the low rigidity material layer is melt-joined to a current collector (a positive electrode current collector or a negative electrode current collector), and the high rigidity material layer is melt-joined to a face of the low rigidity material layer at an opposite side from a face thereof that is melt-joined to the current collector.

A configuration of a bipolar battery according to an embodiment of the present disclosure will be explained as an example, with reference to the drawings. It should be noted that, in the respective drawings, identical or corresponding portions are appended with the same reference numerals, and duplicate explanation is omitted.

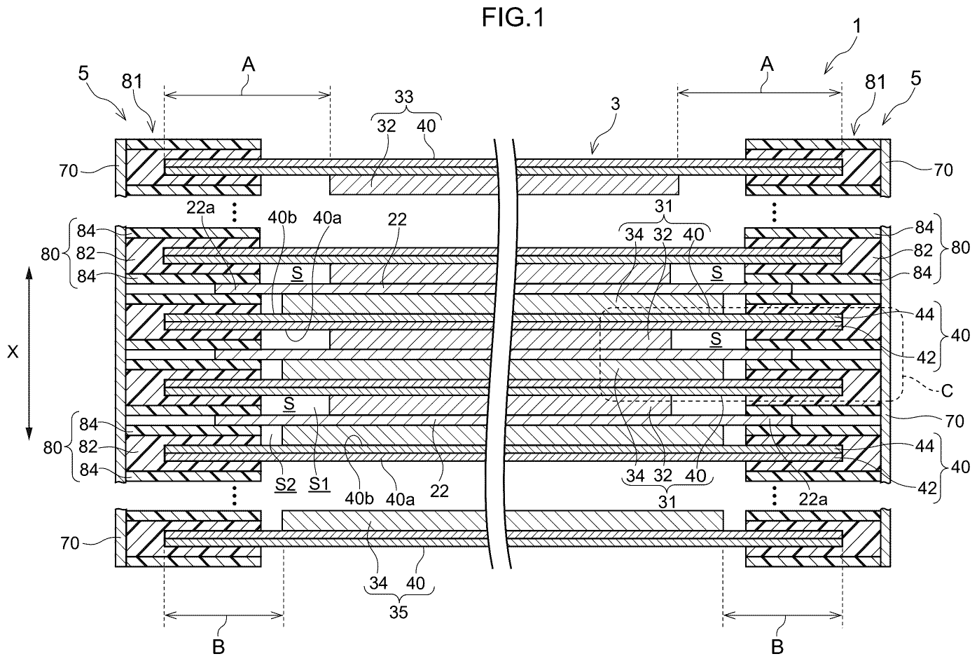

FIG. 1 is a schematic cross-sectional view illustrating an overall configuration of an example of a bipolar battery according to an embodiment of the present disclosure. A bipolar battery 1 illustrated in FIG. 1 is, for example, a bipolar battery that is used in a battery of a forklift, a hybrid vehicle, an electric vehicle, or the like. The bipolar battery 1 is, for example, a lithium ion secondary battery.

As illustrated in FIG. 1, the bipolar battery 1 includes a layered body 3 and a sealing body 5. The layered body 3 includes plural bipolar electrodes 31, a positive electrode terminal electrode 33, and a negative electrode terminal electrode 35 that are layered in a layer-stacking direction X. Each bipolar electrode 31 includes a current collector 40, a positive electrode mixture layer 32, and a negative electrode mixture layer 34.

The current collector 40 has, for example, a rectangular shape when viewed from the layer-stacking direction X. The current collector 40 includes a surface 40a, and a surface 40b at an opposite side from the surface 40a. The current collector 40 includes a first layer 42 and a second layer 44 that are layered in the layer-stacking direction X. The first layer 42 and the second layer 44 are electrically connected to each other. The surface 40a of the current collector 40 is a surface of the first layer 42. The surface 40b of the current collector 40 is a surface of the second layer 44.

The positive electrode mixture layer 32 is provided at the surface 40a of the current collector 40. The positive electrode mixture layer 32 has, for example, a rectangular shape when viewed from the layer-stacking direction X. The surface 40a includes a positive electrode mixture unformed region A at which the positive electrode mixture layer 32 is not provided. The positive electrode mixture unformed region A surrounds the positive electrode mixture layer 32 when viewed from the layer-stacking direction X. The negative electrode mixture layer 34 is provided at the surface 40b of the current collector 40. The negative electrode mixture layer 34 has, for example, a rectangular shape when viewed from the layer-stacking direction X. The surface 40b includes a negative electrode mixture unformed region B at which the negative electrode mixture layer 34 is not provided. The negative electrode mixture unformed region B surrounds the negative electrode mixture layer 34 when viewed from the layer-stacking direction X. The plural bipolar electrodes 31 are stacked such that the positive electrode mixture layer 32 of one bipolar electrode 31 and the negative electrode mixture layer 34 of another bipolar electrode 31 face each other. Namely, the plural bipolar electrodes 31 are stacked such that, among adjacent bipolar electrodes 31, the surface 40a of the current collector 40 of one bipolar electrode 31 and the surface 40b of the current collector 40 of another bipolar electrode 31 face each other.

The positive electrode terminal electrode 33 is disposed at the other side in the layer-stacking direction X with respect to the plural bipolar electrodes 31. The positive electrode terminal electrode 33 includes a current collector 40 and a positive electrode mixture layer 32. The positive electrode terminal electrode 33 is different from the bipolar electrodes 31 in that it does not include a negative electrode mixture layer 34. Except for this difference, the configuration of the positive electrode terminal electrode 33 is the same as that of the bipolar electrodes 31. The positive electrode terminal electrode 33 is disposed such that the positive electrode mixture layer 32 of the positive electrode terminal electrode 33 faces the negative electrode mixture layer 34 of a bipolar electrode 31. Namely, the positive electrode terminal electrode 33 is disposed such that the surface 40a of the current collector 40 of the positive electrode terminal electrode 33 and the surface 40b of the current collector 40 of a bipolar electrode 31 that is adjacent to the positive electrode terminal electrode 33 face each other.

The negative electrode terminal electrode 35 is disposed at another side in the layer-stacking direction X with respect to the plural bipolar electrodes 31. The negative electrode terminal electrode 35 includes a current collector 40 and a negative electrode mixture layer 34. The negative electrode terminal electrode 35 is different from the bipolar electrodes 31 in that it does not include a positive electrode mixture layer 32. Except for this difference, the configuration of the negative electrode terminal electrode 35 is the same as that of the bipolar electrodes 31. The negative electrode terminal electrode 35 is disposed such that the negative electrode mixture layer 34 of the negative electrode terminal electrode 35 faces the positive electrode mixture layer 32 of a bipolar electrode 31. Namely, the negative electrode terminal electrode 35 is disposed such that the surface 40b of the current collector 40 of the negative electrode terminal electrode 35 and the surface 40a of the current collector 40 of a bipolar electrode 31 that is adjacent to the negative electrode terminal electrode 35 face each other.

An internal space S in which an electrolytic solution is accommodated is formed between respective bipolar electrodes 31, between a bipolar electrode 31 and the positive electrode terminal electrode 33, and between a bipolar electrode 31 and the negative electrode terminal electrode 35.

The layered body 3 includes plural separators 22. The separators 22 are disposed between respective bipolar electrodes 31, between a bipolar electrode 31 and the positive electrode terminal electrode 33, and between a bipolar electrode 31 and the negative electrode terminal electrode 35. Each separator 22 is positioned between a positive electrode mixture layer 32 and a negative electrode mixture layer 34 that face each other. Each separator 22 has, for example, a sheet shape. Each separator 22 has, for example, a rectangular shape when viewed from the layer-stacking direction X. When viewed from the layer-stacking direction X, outer edges of the separators 22 are respectively positioned further toward an outer side than outer edges of the positive electrode mixture layers 32 and outer edges of the negative electrode mixture layers 34. The separators 22 are members that allows charge carriers such as lithium ions to pass through. The separators 22 separate respective electrodes 31, 33, and 35 that are adjacent to each other. Consequently, electrical short-circuiting due to contact between the respective electrodes 31, 33, and 35 is prevented.

The current collector 40 is a chemically inert electrical conductor for causing current to continue to flow through the positive electrode mixture layer 32 and the negative electrode mixture layer 34 during discharging or charging of the lithium ion secondary battery. In the present embodiment, the first layer 42 of the current collector 40 includes aluminum, and is, for example, an aluminum foil. In the present embodiment, the second layer 44 of the current collector 40 includes copper, and is, for example, a copper foil.

The sealing body 5 is a member that seals the internal spaces S. The sealing body 5 is provided at side faces of the layered body 3. The sealing body 5 seals the side faces of the layered body 3. Each unit of the sealing body 5 has, for example, a hollow rectangular cylinder shape. The sealing body 5 has electrical insulating properties. The sealing body 5 includes a main body portion 81 and a welded portion 70. The main body portion 81 is provided at an outer peripheral portion of the layered body 3. The main body portion 81 is configured by plural independent members. The main body portion 81 includes plural wrinkle suppression sealing layers 80 serving as resin sealing layers. Each wrinkle suppression sealing layer 80 includes a low rigidity material layer 82, and high rigidity material layers 84 that cover both faces of the low rigidity material layer 82.

A peripheral portion 22a of the separator 22 is positioned between a pair of wrinkle suppression sealing layers 80. The peripheral portion 22a of the separator 22 is sandwiched by the pair of wrinkle suppression sealing layers 80. The separator 22 partitions the internal space S into a first region S1 and a second region S2. The first region S1 is a region that is surrounded by the separator 22, the positive electrode mixture layer 32, the current collector 40, and the wrinkle suppression sealing layer 80, in the internal space S. The second region S2 is a region that is surrounded by the separator 22, the negative electrode mixture layer 34, the current collector 40, and the wrinkle suppression sealing layer 80, in the internal space S.

The volume of the first region S1 is larger than the volume of the second region S2. Specifically, when viewed from the layer-stacking direction X, the area of the positive electrode mixture layer 32 is smaller than the area of the negative electrode mixture layer 34. When viewed from the layer-stacking direction X, the outer edge of the positive electrode mixture layer 32 is positioned further toward the inner side than the outer edge of the negative electrode mixture layer 34. Further, the peripheral portion 22a of the separator 22 is positioned between the pair of wrinkle suppression sealing layers 80. Due to such a configuration, the volume of the first region S1 is larger than the volume of the second region S2.

The welded portion 70 is provided at the outer side of the main body portion 81. The welded portion 70 has, for example, a hollow rectangular cylinder shape. The welded portion 70 reaches both ends of the layered body 3 in the layer-stacking direction X. The welded portion 70 is integrally formed. The welded portion 70 is formed by melting the respective outer edge portions of the respective wrinkle suppression sealing layers 80, and thereafter resolidifying them to perform welding. The welded portion 70 is formed by welding a portion of a region of each wrinkle suppression sealing layer 80 that is positioned further toward the outer side than outer edges of the current collectors 40 when viewed from the layer-stacking direction X. The welded portion 70 does not reach the outer edges of the respective current collectors 40.

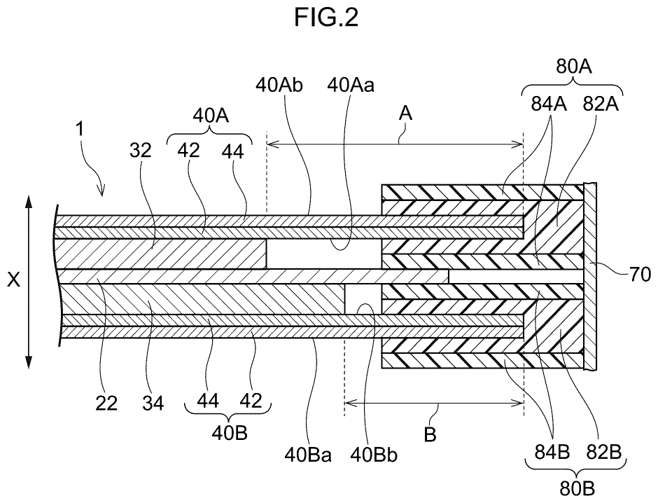

Next, explanation will be provided by focusing on a pair of bipolar electrodes 31 that are adjacent to each other, with reference to FIG. 2 illustrating an enlarged view of a region C of the bipolar battery 1 illustrated in FIG. 1. FIG. 2 is a schematic cross-sectional view illustrating an enlarged view of a portion of the bipolar battery illustrated in FIG. 1.

The bipolar battery 1 illustrated in FIG. 2 includes a separator 22, a positive electrode mixture layer 32 that is provided in contact with one side of the separator 22, a current collector that is provided in contact with a face of the positive electrode mixture layer 32 at a side opposite from the separator 22 (hereinafter, in FIG. 2, the current collector in contact with the positive electrode mixture layer 32 is referred to as a “positive electrode current collector 40A”), a negative electrode mixture layer 34 that is provided in contact with the other side of the separator 22, and a current collector that is provided in contact with a face of the negative electrode mixture layer 34 at a side opposite from the separator 22 (hereinafter, in FIG. 2, the current collector in contact with the negative electrode mixture layer 34 is referred to as a “negative electrode current collector 40B”). Each of the positive electrode current collector 40A and the negative electrode current collector 40B includes a first layer 42 and a second layer 44. As illustrated in FIG. 1, in the bipolar battery 1, plural bipolar electrodes 31, each including a negative electrode mixture layer 34 disposed on one side of a current collector (the positive electrode current collector 40A and the negative electrode current collector 40B) and including a positive electrode mixture layer 32 disposed on the other side of the current collector, are stacked with a separator 22 interposed therebetween. It should be noted that, when the bipolar battery 1 is viewed from the layer-stacking direction X, a positive electrode mixture unformed region A at which the positive electrode mixture layer 32 is not formed is present on a face of the positive electrode current collector 40A, and a negative electrode mixture unformed region B at which the negative electrode mixture layer 34 is not formed is present on a face of the negative electrode current collector 40B.

A wrinkle suppression sealing layer serving as a positive electrode side resin sealing layer that is provided in contact with both of a face of the positive electrode current collector 40A at a side opposite from the positive electrode mixture layer 32 (namely, a surface 40Ab) and a face of the positive electrode current collector 40A at a side that the positive electrode mixture layer 32 contacts (namely, a surface 40Aa) (hereafter, in FIG. 2, the wrinkle suppression sealing layer in contact with the positive electrode current collector 40A is referred to as a “positive electrode side wrinkle suppression sealing layer 80A”) is disposed at the positive electrode mixture unformed region A. The positive electrode side wrinkle suppression sealing layer 80A is formed by respectively disposing two sets of a low rigidity material layer and a high rigidity material layer on the face (surface 40Ab) of the positive electrode current collector 40A at the side opposite from the positive electrode mixture layer 32 and the face (surface 40Aa) of the positive electrode current collector 40A at the side that the positive electrode mixture layer 32 contacts, and thereafter performing heat sealing (thermal fusion). Specifically, first, a low rigidity material layer and a high rigidity material layer are disposed at the face of the positive electrode current collector 40A at the side opposite from the positive electrode mixture layer 32, such that they project out from the outer edge of the positive electrode current collector 40A (such that they project out to a region further toward a right side than an end of the positive electrode current collector 40A in FIG. 2). Further, a low rigidity material layer and a high rigidity material layer are also disposed at the face (surface 40Aa) of the positive electrode current collector 40A at the side that the positive electrode mixture layer 32 contacts, such that they project out from the outer edge of the positive electrode current collector 40A (such that they project out to the region further toward the right side than the end of the positive electrode current collector 40A in FIG. 2). Thereafter, the positive electrode side wrinkle suppression sealing layer 80A is formed by heat sealing (thermally fusing) the low rigidity material layers and the high rigidity material layers of the two sets that have been disposed at the face (surface 40Ab) of the positive electrode current collector 40A at the side opposite from the positive electrode mixture layer 32 and at the face (surface 40Aa) of the positive electrode current collector 40A at the side that the positive electrode mixture layer 32 contacts. The low rigidity material layers of the two sets configure a low rigidity material layer 82A that is integrated by heat sealing in a region further toward the outer side than the outer edge of the positive electrode current collector 40A (further toward the right side than the end of the positive electrode current collector 40A in FIG. 2). Namely, the low rigidity material layer 82A is integrally formed in a shape that is folded at the outer edge of the positive electrode current collector 40A, and the low rigidity material layer 82A is disposed so as to cover both of the face (surface 40Ab) of the positive electrode current collector 40A at the side opposite from the positive electrode mixture layer 32 and the face (surface 40Aa) of the positive electrode current collector 40A at the side that the positive electrode mixture layer 32 contacts. Further, high rigidity material layers 84A are respectively disposed so as to cover both faces of the low rigidity material layer 82A that covers both faces of the positive electrode current collector 40A (namely, so as to respectively cover an upper side and a lower side of the low rigidity material layer 82A in FIG. 2).

It should be noted that the low rigidity material layer 82A in the positive electrode side wrinkle suppression sealing layer 80A covers the surface 40Aa of the positive electrode current collector 40A, the surface 40Ab of the positive electrode current collector 40A, and a side face (an outer edge face) of the positive electrode current collector 40A. The low rigidity material layer 82A is joined to the surface 40Aa, the surface 40Ab, and the side face of the positive electrode current collector 40A.

A wrinkle suppression sealing layer serving as a negative electrode side resin sealing layer that is provided in contact with both of a face of the negative electrode current collector 40B at a side opposite from the negative electrode mixture layer 34 (namely, a surface 40Ba) and a face of the negative electrode current collector 40B at a side that the negative electrode mixture layer 34 contacts (namely, a surface 40Bb) (hereafter, in FIG. 2, the wrinkle suppression sealing layer in contact with the negative electrode current collector 40B is referred to as a “negative electrode side wrinkle suppression sealing layer 80B”) is disposed at the negative electrode mixture unformed region B. The negative electrode side wrinkle suppression sealing layer 80B is formed by respectively disposing two sets of a low rigidity material layer and a high rigidity material layer on the face (surface 40Ba) of the negative electrode current collector 40B at the side opposite from the negative electrode mixture layer 34 and the face (surface 40Bb) of the negative electrode current collector 40B at the side that the negative electrode mixture layer 34 contacts, and thereafter performing heat sealing (thermal fusion). Specifically, first, a low rigidity material layer and a high rigidity material layer are disposed at the face (surface 40Ba) of the negative electrode current collector 40B at the side opposite from the negative electrode mixture layer 34, such that they project out from the outer edge of the negative electrode current collector 40B (such that they project out to a region further toward the right side than an end of the negative electrode current collector 40B in FIG. 2). Further, a low rigidity material layer and a high rigidity material layer are also disposed at the face (surface 40Bb) of the negative electrode current collector 40B at the side that the negative electrode mixture layer 34 contacts, such that they project out from the outer edge of the negative electrode current collector 40B (such that they project out to the region further toward the right side than the end of the negative electrode current collector 40B in FIG. 2). Thereafter, the negative electrode side wrinkle suppression sealing layer 80B is formed by heat sealing (thermally fusing) the low rigidity material layers and the high rigidity material layers of the two sets that have been disposed at the face (surface 40Ba) of the negative electrode current collector 40B at the side opposite from the negative electrode mixture layer 34 and at the face (surface 40Bb) of the negative electrode current collector 40B at the side that the negative electrode mixture layer 34 contacts. The low rigidity material layers of the two sets configure a low rigidity material layer 82B that is integrated by heat sealing in a region further toward the outer side than the outer edge of the negative electrode current collector 40B (further toward the right side than the end of the negative electrode current collector 40B in FIG. 2). Namely, the low rigidity material layer 82B is integrally formed in a shape that is folded at the outer edge of the negative electrode current collector 40B, and the low rigidity material layer 82B is disposed so as to cover both of the face (surface 40Ba) of the negative electrode current collector 40B at the side opposite from the negative electrode mixture layer 34 and the face (surface 40Bb) of the negative electrode current collector 40B at the side that the negative electrode mixture layer 34 contacts. Further, high rigidity material layers 84B are respectively disposed so as to cover both faces of the low rigidity material layer 82B that covers both faces of the negative electrode current collector 40B (namely, so as to respectively cover an upper side and a lower side of the low rigidity material layer 82B in FIG. 2).

It should be noted that the low rigidity material layer 82B in the negative electrode side wrinkle suppression sealing layer 80B covers the surface 40Ba of the negative electrode current collector 40B, the surface 40Bb of the negative electrode current collector 40B, and a side face (an outer edge face) of the negative electrode current collector 40B. The low rigidity material layer 82B is joined to the surface 40Ba, the surface 40Bb, and the side face of the negative electrode current collector 40B.

The low rigidity material layer 82A in the positive electrode side wrinkle suppression sealing layer 80A has a tensile modulus of elasticity of less than 35.0 kgf/mm², and the high rigidity material layers 84A have a tensile modulus of elasticity of 35.0 kgf/mm² or more.

The low rigidity material layer 82B in the negative electrode side wrinkle suppression sealing layer 80B has a tensile modulus of elasticity of less than 35.0 kgf/mm², and the high rigidity material layers 84B have a tensile modulus of elasticity of 35.0 kgf/mm² or more.

It should be noted that, in cases in which each resin sealing layer (the positive electrode side wrinkle suppression sealing layer 80A and the negative electrode side wrinkle suppression sealing layer 80B in FIG. 2) is configured from only one resin layer, wrinkles may occur, or warping may occur, at the positive electrode current collector and the negative electrode current collector. This is considered to be due to thermal expansion and contraction occurring at the positive electrode mixture unformed region of the positive electrode current collector and the negative electrode mixture unformed region of the negative electrode current collector due to heating and cooling of the heat sealing (thermal fusion) that is performed when the resin sealing layers are layered on the positive electrode mixture unformed region of the positive electrode current collector and the negative electrode mixture unformed region of the negative electrode current collector.

In contrast thereto, each resin sealing layer (in FIG. 2, the positive electrode side wrinkle suppression sealing layer 80A and the negative electrode side wrinkle suppression sealing layer 80B) in the bipolar battery according to the present embodiment of the present disclosure includes a low rigidity material layer at the side thereof that is in contact with the current collector, and includes a high rigidity material layer at the side thereof that is not in contact with the current collector (namely, on the face of the low rigidity material layer at a side opposite from the current collector). Consequently, in the melt-joining of the resin sealing layer to the current collector, thermal expansion and contraction of the resin sealing layer caused by heating and cooling during the heat sealing are reduced by the high rigidity material layer. As a result, occurrence of wrinkles and occurrence of warping, due to stress being concentrated at the positive electrode current collector and the negative electrode current collector, are reduced.

Further, due to the resin sealing layer including the high rigidity material layer at the side thereof that is not in contact with the current collector, influence on the surroundings due to the thermal expansion and contraction is also reduced. For example, although slight undulations may occur at the positive electrode mixture unformed region and the negative electrode mixture unformed region of the current collectors, and electrode undulations may accumulate when batteries are stacked and modularized in the post-process, accumulation of the electrode undulations is reduced due to providing the high rigidity material layer. Moreover, by providing the high rigidity material layer, variation in module thickness when stacking and modularizing the batteries is also reduced.

It should be noted that in the bipolar battery 1 illustrated in FIGS. 1 and 2, the positive electrode side wrinkle suppression sealing layer 80A and the negative electrode side wrinkle suppression sealing layer 80B are interposed between the positive electrode current collector 40A and the separator 22, and between the negative electrode current collector 40B and the separator 22. Consequently, placement of a spacer between the positive electrode current collector 40A and the negative electrode current collector 40B can be omitted.

On the other hand, in the bipolar battery according to embodiments of the present disclosure, a spacer can be provided at a void at the positive electrode mixture unformed region and the negative electrode mixture unformed region between the positive electrode current collector and the negative electrode current collector. The spacer includes, for example, an electrically insulating material, and insulates between the positive electrode current collector and the negative electrode current collector, thereby preventing short-circuiting between the current collectors. Examples of the material configuring the spacer include various resin materials such as polyethylene (PE), polystyrene, ABS resin, modified polypropylene (modified PP), and acrylonitrile styrene (AS) resin.

It should be noted that, although FIG. 2 illustrates a configuration in which resin sealing layers are respectively provided at both of the face (surface 40Ab) of the positive electrode current collector 40A at the side opposite from the positive electrode mixture layer 32 and the face (surface 40Aa) of the positive electrode current collector 40A at the side that the positive electrode mixture layer 32 contacts, and at both of the face (surface 40Ba) of the negative electrode current collector 40B at the side opposite from the negative electrode mixture layer 34 and the face (surface 40Bb) of the negative electrode current collector 40B at the side that the negative electrode mixture layer 34 contacts, the present disclosure is not limited to this aspect. Namely, the resin sealing layer may be provided only at one face of each of the positive electrode current collector and the negative electrode current collector.

In this regard, an aspect in which the resin sealing layer is provided only at one face of each of the positive electrode current collector and the negative electrode current collector in a bipolar battery according to an embodiment of the present disclosure will be explained as an example.

### Another Aspect

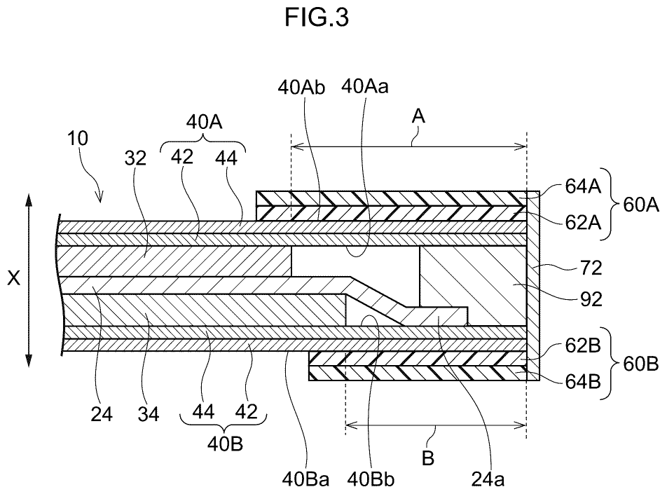

FIG. 3 is a schematic cross-sectional view illustrating another example of a bipolar battery according to an embodiment of the present disclosure.

In the bipolar battery 10 illustrated in FIG. 3, configurations of the positive electrode mixture layer 32, the positive electrode current collector 40A, the negative electrode mixture layer 34, and the negative electrode current collector 40B are the same as the configurations illustrated in FIG. 2, and therefore, detailed explanation thereof is omitted here.

In the bipolar battery 10 illustrated in FIG. 3, a separator 24 is positioned between the positive electrode mixture layer 32 and the negative electrode mixture layer 34, which face each other. The separator 24 has, for example, a sheet shape. The separator 24 has, for example, a rectangular shape when viewed from the layer-stacking direction X. When viewed from the layer-stacking direction X, the outer edge of the separator 24 is positioned further toward the outer side than each of the outer edge of the positive electrode mixture layer 32 and the outer edge of the negative electrode mixture layer 34. A peripheral portion 24a of the separator 24 is refracted toward a negative electrode current collector 40B side, and a partial region of the peripheral portion 24a including the outer edge is in contact with the negative electrode current collector 40B.

When the bipolar battery 10 is viewed from the layer-stacking direction X, a positive electrode mixture unformed region A at which the positive electrode mixture layer 32 is not formed is present on the face of the positive electrode current collector 40A, and a negative electrode mixture unformed region B at which the negative electrode mixture layer 34 is not formed is present on the face of the negative electrode current collector 40B.

The bipolar battery 10 illustrated in FIG. 3 includes a separator 24 between the positive electrode mixture layer 32 at the positive electrode mixture unformed region A and the negative electrode mixture layer 34 at the negative electrode mixture unformed region B. The separator 24 is sandwiched between the positive electrode mixture layer 32 at a region other than the positive electrode mixture unformed region A and the negative electrode mixture layer 34 at a region other than the negative electrode mixture unformed region B. The separator 24 has, for example, a rectangular frame shape. A spacer 92, together with the separator 24, the positive electrode mixture layer 32, and the positive electrode current collector 40A, surround an internal space for accommodating an electrolytic solution. The separator 24 is in contact with each of the positive electrode mixture layer 32 and the negative electrode mixture layer 34. The spacer 92 is in contact with the peripheral portion 24a at a portion of the region at which the peripheral portion 24a of the separator 24 is in contact with the negative electrode current collector 40B. The spacer 92 is joined to none of the positive electrode mixture layer 32, the negative electrode mixture layer 34, or the separator 24. The inner edge of the spacer 92 is positioned away from the positive electrode mixture layer 32 and the negative electrode mixture layer 34 toward the outer side when viewed from the layer-stacking direction. The outer edge of the spacer 92 substantially coincides with each of the outer edge of the positive electrode side wrinkle suppression sealing layer 60A and the outer edge of the negative electrode side wrinkle suppression sealing layer 60B when viewed from the layer-stacking direction.

The spacer 92 includes, for example, an electrically insulating material, and insulates between the positive electrode current collector and the negative electrode current collector, thereby preventing short-circuiting between the current collectors. Examples of the material configuring the spacer 92 include various resin materials such as polyethylene (PE), polystyrene, ABS resin, modified polypropylene (modified PP), and acrylonitrile styrene (AS) resin.

A welded portion 72 is formed by melting the respective outer edge portions of the positive electrode side wrinkle suppression sealing layer 60A, the negative electrode side wrinkle suppression sealing layer 60B, and the spacer 92, and thereafter resolidifying them to perform welding.

A wrinkle suppression sealing layer serving as a positive electrode side resin sealing layer that is provided in contact with the face (namely, the surface 40Ab) of the positive electrode current collector 40A at the side opposite from the positive electrode mixture layer 32 (hereafter, in FIG. 3, the wrinkle suppression sealing layer in contact with the positive electrode current collector 40A is referred to as a “positive electrode side wrinkle suppression sealing layer 60A”) is disposed at the positive electrode mixture unformed region A. It should be noted that the positive electrode side wrinkle suppression sealing layer 60A is disposed so as to cover all the positive electrode mixture unformed region A at the face (surface 40Ab) of the positive electrode current collector 40A at the side opposite from the positive electrode mixture layer 32, and so as to cover up to a region that is not the positive electrode mixture unformed region A. It should also be noted that the low rigidity material layer 62A in the positive electrode side wrinkle suppression sealing layer 60A is joined to the surface 40Ab of the positive electrode current collector 40A.

A wrinkle suppression sealing layer serving as a negative electrode side resin sealing layer that is provided in contact with the face (namely, the surface 40Ba) of the negative electrode current collector 40B at the side opposite from the negative electrode mixture layer 34 (hereafter, in FIG. 3, the wrinkle suppression sealing layer in contact with the negative electrode current collector 40B is referred to as a “negative electrode side wrinkle suppression sealing layer 60B”) is disposed at the negative electrode mixture unformed region B. It should be noted that the negative electrode side wrinkle suppression sealing layer 60B is disposed so as to cover all of the negative electrode mixture unformed region B at the face (surface 40Ba) of the negative electrode current collector 40B at the side opposite from the negative electrode mixture layer 34, and so as to cover up to a region that is not the negative electrode mixture unformed region B. It should also be noted that the low rigidity material layer 62B in the negative electrode side wrinkle suppression sealing layer 60B is joined to the surface 40Ba of the negative electrode current collector 40B.

The positive electrode side wrinkle suppressing sealing layer 60A includes the low rigidity material layer 62A having a tensile modulus of elasticity of less than 35.0 kgf/mm², and a high rigidity material layer 64A having a tensile modulus of elasticity of 35.0 kgf/mm² or more that is provided in contact with a face of the low rigidity material layer 62A at a side opposite from the separator 24 The negative electrode side wrinkle suppressing sealing layer 60B includes the low rigidity material layer 62B having a tensile modulus of elasticity of less than 35.0 kgf/mm², and a high rigidity material layer 64B having a tensile modulus of elasticity of 35.0 kgf/mm² or more that is provided in contact with a face of the low rigidity material layer 62B at a side opposite from the separator 24.

In the bipolar battery according to embodiments of the present disclosure, in the aspect in which the resin sealing layer is provided only at one face of each of the positive electrode current collector and the negative electrode current collector as well, generation of wrinkles and warping at the positive electrode mixture unformed region A of the positive electrode current collector and the negative electrode mixture unformed region B of the negative electrode current collector is reduced. This is owing to the configuration in which the resin sealing layer includes the low rigidity material layer at the side thereof that is in contact with the current collector, and includes the high rigidity material layer at the side thereof that is not in contact with the current collector. The reason why the foregoing effect is obtained with the configuration is considered to be that, in melt-joining of the resin sealing layer to the current collector, thermal expansion and contraction of the resin sealing layer caused by heating and cooling during heat sealing are reduced by the high rigidity material layer, and that concentration of stress at the positive electrode current collector and the negative electrode current collector is thereby reduced.

Further, due to the resin sealing layer including the high rigidity material layer at the side thereof that is not in contact with the current collector, influence on the surroundings due to thermal expansion and contraction is also reduced. For example, although slight undulations may occur at the positive electrode mixture unformed region and the negative electrode mixture unformed region of the current collectors, and electrode undulations may accumulate when batteries are stacked and modularized in the post-process, accumulation of the electrode undulations is reduced due to providing the high rigidity material layer. Moreover, by providing the high rigidity material layer, variation in module thickness when stacking and modularizing the batteries is also reduced.

### Resin Sealing Layers

The resin sealing layers (the positive electrode side wrinkle suppression sealing layer 80A and the negative electrode side wrinkle suppression sealing layer 80B in FIG. 2, and the positive electrode side wrinkle suppression sealing layer 60A and the negative electrode side wrinkle suppression sealing layer 60B in FIG. 3) each include a low rigidity material layer having a tensile modulus of elasticity of less than 35.0 kgf/mm², and a high rigidity material layer having a tensile modulus of elasticity of 35.0 kgf/mm² or more. Due to the tensile modulus of elasticity of the low rigidity material layer and the tensile modulus of elasticity of the high rigidity material layer being in the aforementioned ranges, generation of wrinkles and warping in the positive electrode current collector and the negative electrode current collector is reduced. Further, due to the tensile modulus of elasticity of the high rigidity material layer being in the aforementioned range, influence on the surroundings of thermal expansion and contraction due to heat sealing when providing the resin sealing layers is reduced.

It is further preferable that the tensile modulus of elasticity of the low rigidity material layer is from 1.4 kgf/mm² to 26.7 kgf/mm², from the perspectives of reducing generation of wrinkles and warping in the positive electrode current collector and the negative electrode current collector, and ensuring strength of the low rigidity material layer.

It is further preferable that the tensile modulus of elasticity of the high rigidity material layer is from 42.2 kgf/mm² to 127.0 kgf/mm², from the perspectives of reducing generation of wrinkles and warping in the positive electrode current collector and the negative electrode current collector, reducing influence on the surroundings due to thermal expansion and contraction, and enabling the resin sealing layer to be easily formed by heat sealing (thermal fusion).

An example of the material configuring the low rigidity material layer is a material including at least one selected from low density polyethylene (LDPE) or ethylene-vinyl acetate copolymer resin (EVA), and may be a material including one of LDPE or EVA or both of LDPE and EVA.

Low density polyethylene (LDPE) means a polyethylene having a specific density of from 0.910 to 0.930, and the tensile modulus of elasticity thereof is, for example, from 9.8 kgf/mm² to 26.7 kgf/mm². Low density polyethylene (LDPE) also includes linear low density polyethylene (LLDPE).

The tensile modulus of elasticity of ethylene-vinyl acetate copolymer resin (EVA) is, for example, from 1.4 kgf/mm² to 8.4 kgf/mm².

An example of the material configuring the high rigidity material layer include a material including at least one selected from an ionomer, cast polypropylene (CPP), or high density polyethylene (HDPE), and may be a material including one type, two types, or three types selected from an ionomer, CPP, or HDPE.

Ionomers are synthetic resins obtained by forming aggregates of high-molecular compounds through utilization of cohesive force of metal ions, and include, for example, a resin obtained by ionically cross-linking a polymer including a polyethylene unit and an acrylic acid unit with a metal.

Cast polypropylene (CPP) means a polypropylene resin that has not been stretched, and the tensile modulus of elasticity thereof is, for example, from 63.2 kgf/mm² to 64.3 kgf/mm².

High density polyethylene (HDPE) means a polyethylene having a specific density of from 0.942 to 0.970, and the tensile modulus of elasticity thereof is, for example, from 42.2 kgf/mm² to 127.0 kgf/mm².

As combinations of materials for the low rigidity material layer and the high rigidity material layer, for example, the following combinations (1) to (3) are preferable.
(1) A combination of: a material including LDPE (more preferably, a material consisting of LDPE) for the low rigidity material layer; and a material including an ionomer (more preferably, a material consisting of an ionomer) for the high rigidity material layer
(2) A combination of: a material including LLDPE (more preferably, a material consisting of LLDPE) for the low rigidity material layer; and a material including CPP (more preferably, a material consisting of CPP) for the high rigidity material layer
(3) A combination of: a material including LDPE (more preferably, a material consisting of LDPE) for the low rigidity material layer; and a material including HDPE (more preferably, a material consisting of HDPE) for the high rigidity material layer

It should be noted that, in the present disclosure, measurement of tensile modulus of elasticity is performed according to JIS K 7127 (1999).

The average thickness of the low rigidity material layer in the resin sealing layer is preferably from 10 μm to 100 μm, and more preferably from 20 μm to 70 μm, from the perspectives of reducing generation of wrinkles and warping in the positive electrode current collector and the negative electrode current collector, and ensuring strength of the low rigidity material layer. The average thickness of the high rigidity material layer is preferably from 10 μm to 100 μm, and more preferably from 20 μm to 70 μm, from the perspectives of reducing generation of wrinkles and warping in the positive electrode current collector and the negative electrode current collector, reducing influence on the surroundings due to thermal expansion and contraction, and enabling the resin sealing layer to be easily formed by heat sealing (thermal fusion).

The average thickness of the entire resin sealing layer is preferably from 20 μm to 300 μm, and more preferably from 40 μm to 200 μm.

It should be noted that an average thickness means an arithmetic average value of thicknesses at 10 arbitrarily selected locations.

The resin sealing layer includes at least the low rigidity material layer and the high rigidity material layer. Namely, it may have a structure consisting of two layers, which are the low rigidity material layer and the high rigidity material layer, or it may have a structure consisting of three or more layers including plural layers of at least one of the low rigidity material layer or the high rigidity material layer. However, from the perspective of ease of formation of the resin sealing layer, it is preferable that it has a structure consisting of two layers, which are the low rigidity material layer and the high rigidity material layer.

Next, other elements of the bipolar battery according to embodiments of the present disclosure will be explained.

### Positive Electrode Mixture Layer

The positive electrode mixture layer includes a positive electrode active material, and may further include, for example, a binder.

Examples of the positive electrode active material include a lithium nickel cobalt manganese complex oxide (hereinafter sometimes simply referred to as “LNCM”). The simplest LNCM is represented by the following general formula: LiNiₓCo_{y}Mn_{z}O₂ (in which x, y, and z satisfy 0<x<1, 0<y<1, 0<z<1, and x+y +z=1). The LNCM may contain, in addition to Li, Ni, Co, and Mn, other additional elements, such as transition metal elements other than Ni, Co, and Mn and main-group metal elements other than Li. The LNCM has a layered crystal structure. The LNCM preferably accounts for more than 50% by mass, for example, from 80 to 100% by mass, of the entire positive electrode active material. The positive electrode active material may be composed of LNCM alone. Further, as a positive electrode active material layer, lithium iron phosphate (LiFePO₄, LFP), lithium manganese iron phosphate (LMFP), or the like may be used.

Examples of other positive electrode active materials include lithium nickel complex oxides, lithium cobalt complex oxides, lithium nickel manganese complex oxides, and the like.

Examples of the binder included in the positive electrode mixture layer include a vinyl halide resin such as polyvinylidene fluoride (PVdF).

The positive electrode mixture layer may further include other components, for example, a conductive material. Examples of the conductive material include non-graphitizing carbon, graphitizing carbon such as carbon black, and graphite.

### Negative Electrode Mixture Layer

The negative electrode mixture layer includes a negative electrode active material, and may further include, for example, a binder.

Examples of the negative electrode active material include natural graphite, artificial graphite, and graphite-based carbon such as amorphous coated graphite. The proportion of graphite in the graphite-based carbon is approximately 50% by mass or more, and preferably 80% by mass or more.

Examples of the binder included in the negative electrode active material include a rubber such as a styrene-butadiene copolymer (SBR), and a vinyl halide resin such as polyvinylidene fluoride (PVdF).

The negative electrode mixture layer may further include other components, for example, a thickening agent. Examples of the thickening agent include a cellulose such as carboxymethylcellulose (CMC).

### Current Collector: Positive Electrode Current Collector and Negative Electrode Current Collector

The bipolar battery according to embodiments of the present disclosure includes plural bipolar electrodes that are stacked with a separator interposed therebetween, each bipolar electrode including a negative electrode mixture layer on one side of a current collector (the positive electrode current collector 40A and the negative electrode current collector 40B in FIGS. 2 and 3) and including a positive electrode mixture layer on the other side of the current collector. As the current collector, a conductive member made of a metal having high electric conductivity (for example, aluminum, stainless steel (SUS), Ni, Cr, Au, Pt, Fe, Ti, Zn or the like) is suitable.

### Separator

The separator is an electrically insulating porous film. The separator electrically isolates a positive electrode and a negative electrode. The separator may have a thickness of, for example, from 5 μm to 30 μm. The separator can be configured by, for example, a porous polyethylene (PE) film, a porous polypropylene (PP) film, or the like. The separator may have a multilayer structure. For example, the separator may be configured by providing a porous PP film, a porous PE film, and a porous PP film one on another in this order. The separator may have a heat-resistant layer at a surface thereof. The heat-resistant layer includes a heat-resistant material. Examples of the heat-resistant material include metal oxide particles such as alumina, and a high-melting-point resin such as a polyimide.

### Electrolyte

The bipolar battery according to embodiments of the present disclosure further includes an electrolyte. The electrolyte may be in the form of an electrolytic solution, and a nonaqueous electrolytic solution is particularly preferable. The nonaqueous electrolytic solution will be explained below.

### Solvent

The nonaqueous electrolytic solution includes a solvent (nonaqueous solvent) and an electrolyte.

Examples of the solvent (nonaqueous solvent) include N,N-diethyl-N-methyl-N-(2-methoxyethyl)ammonium bis(fluorosulfonyl)imide (DEME), 1-ethyl-3-methylimidazolium bis(fluorosulfonyl)imide (EMI), 1-ethyl-2,3-dimethylimidazolium bis(fluorosulfonyl)imide (DEMI-FSI), and the like.

### Electrolyte

Examples of the electrolyte in the electrolytic solution include an Li salt. Examples of the Li salt include lithium bis(fluorosulfonyl)imide (LiFSI), LiPF₆ (lithium hexafluorophosphate), lithium tetrafluoroborate (LiBF₄), Li[N(CF₃SO₂)₂], and the like.

The amount of the electrolyte may be, for example, from 1.0 mol/L to 2.0 mol/L, and is preferably from 1.0 mol/L to 1.5 mol/L.

In addition to the solvent and the electrolyte, the electrolytic solution may contain various additives, for example, a thickening agent, a film forming agent, a gas generating agent, and the like. The electrolytic solution is typically a nonaqueous electrolytic solution that is liquid at ordinary temperature (for example, 25±10° C.). The electrolytic solution is typically in a liquid state under a battery usage environment (for example, under a temperature environment of from −20° C. to +60° C.).

### Applications

Examples of applications of the bipolar battery according to embodiments of the present disclosure include a power source of a hybrid electric vehicle (HEV), a plug-in hybrid electric vehicle (PHEV), a battery electric vehicle (BEV), or the like.

### Explanation of Reference Numerals

The respective reference numerals indicate the following elements:
1, 10: Bipolar battery;
3: Layered body;
5: Sealing body;
22, 24: Separator;
31: Bipolar electrode;
32: Positive electrode mixture layer;
33: Positive electrode terminal electrode;
34: Negative electrode mixture layer;
35: Negative electrode terminal electrode;
40: Current collector;
40A: Positive electrode current collector;
40B: Negative electrode current collector;
42: First layer;
44: Second layer;
60A, 80A: Positive electrode side wrinkle suppression sealing layer;
60B, 80B: Negative electrode side wrinkle suppression sealing layer;
62A, 62B, 82A, 82B: Low rigidity material layer;
64A, 64B, 84A, 84B: High rigidity material layer;
70, 72: Welded portion;
80: Wrinkle suppression sealing layer;
81: Main body portion;
92: Spacer;
A: Positive electrode mixture unformed region;
B: Negative electrode mixture unformed region; and
S: Internal space

What is claimed is:

1. A bipolar battery, comprising:
a separator;
a positive electrode mixture layer layered on one side of the separator;
a positive electrode current collector layered on a face of the positive electrode mixture layer at a side opposite from the separator;
a negative electrode mixture layer layered on another side of the separator; and
a negative electrode current collector layered on a face of the negative electrode mixture layer at a side opposite from the separator,
wherein, when viewed from a layer-stacking direction, the bipolar battery includes a positive electrode mixture unformed region at which the positive electrode mixture layer is not formed on a face of the positive electrode current collector, and includes a negative electrode mixture unformed region at which the negative electrode mixture layer is not formed on a face of the negative electrode current collector, and
wherein the bipolar battery comprises a resin sealing layer that includes a low rigidity material layer which has a tensile modulus of elasticity of less than 35.0 kgf/mm² and which is joined to the positive electrode current collector or the negative electrode current collector, and a high rigidity material layer which has a tensile modulus of elasticity of 35.0 kgf/mm² or more and which is disposed on a face of the low rigidity material layer that is opposite from a face thereof that is joined to the positive electrode current collector or the negative electrode current collector.

2. The bipolar battery according to claim 1, wherein the resin sealing layer is layered on a face of the positive electrode current collector at a side opposite from the positive electrode mixture layer in the positive electrode mixture unformed region, and on a face of the negative electrode current collector at a side opposite from the negative electrode mixture layer in the negative electrode mixture unformed region.

3. The bipolar battery according to claim 1, wherein the tensile modulus of elasticity of the low rigidity material layer is from 1.4 kgf/mm² to 26.7 kgf/mm², and the tensile modulus of elasticity of the high rigidity material layer is from 42.2 kgf/mm² to 127.0 kgf/mm².

4. The bipolar battery according to claim 1, wherein the low rigidity material layer includes at least one selected from a low density polyethylene or an ethylene-vinyl acetate copolymer resin, and the high rigidity material layer includes at least one selected from an ionomer, a cast polypropylene, or a high density polyethylene.

5. The bipolar battery according to claim 1, wherein the resin sealing layer consists of two layers, which are the low rigidity material layer and the high rigidity material layer.
